(19) United States
(12) Patent Application Publication
(10) Pub. No.: US 2026/0181507 A1
(43) Pub. Date: Jun. 25, 2026

(54) RACH-LESS RECOVERY FROM RADIO LINK FAILURE (RLF) BASED ON RLF PREDICTIONS

(71) Applicant: InterDigital Patent Holdings, Inc., Wilmington, DE (US)

(72) Inventors: Oumer Teyeb, Montreal (CA); Brian Martin, Farnham (GB); Yugeswar Deenoo Narayanan Thangaraj, Chalfont, PA (US); Dylan Watts, Montreal (CA)

(73) Assignee: InterDigital Patent Holdings, Inc., Wilmington, DE (US)

(21) Appl. No.: 18/990,079

(22) Filed: Dec. 20, 2024

(51) Int. Cl. H04W 36/30; H04W 24/08; H04W 74/0833; H04W 76/18

(52) U.S. Cl. CPC H04W 36/305; H04W 24/08; H04W 74/0833; H04W 76/18

(57) ABSTRACT

A wireless transmit/receive unit (WTRU) comprises a processor configured to send capability information related to radio link failure (RLF) prediction based on an artificial intelligence (AI)/machine learning (ML) model, receive configuration information associated with radio link monitoring (RLM) and RLF detection and prediction, wherein the configuration information comprises an early synchronization configuration associated with a target cell for RLF recovery. The processor may predict radio link failure of a serving cell of the WTRU at a predicted RLF time, perform early synchronization with the target cell based on the early synchronization configuration, detect a RLF of the serving cell at the predicted RLF time or within a time window that includes the predicted RFL time, and perform a recovery of a connection via the target cell.

### BACKGROUND

A wireless transmit/receive unit (WTRU) may use an artificial intelligence (AI)/machine learning (ML) model to predict a radio link failure (RLF) before it actually happens and may take a recovery action based on that. This recovery action could be a re-establishment and/or the execution of a conditional handover (CHO)/L1/L2 triggered mobility (LTM) to a candidate cell (e.g., if the best cell at the time of the RLF prediction has an associated CHO/LTM configuration).

Performing preemptive recovery based on RLF prediction, especially re-establishment, may be costly if the prediction was not correct. For example, the WTRU may experience unnecessary data interruption and/or loss, and the contributing factors to this interruption/loss may be as follows. For instance, the contributing factor to this interruption/loss may be the random access (RA) procedure the WTRU performs to the target, during which WTRU won't be able to transmit/receive data. The contributing factor to this interruption/loss may be the flushing of the layer 2 (L2)/layer 3 (L3) buffers (e.g., pending downlink (DL)/uplink (UL) data may have to be retransmitted from/to the target, which may include data forwarding between the source and target). The contributing factor to this interruption/loss may be the need to reconfigure the WTRU (e.g., if it was re-establishment, WTRU needs a separate radio resource control (RRC) reconfiguration after the re-establishment to reconfigure all the bearers, etc.).

One approach may be to not perform a full recovery action (e.g., re-establishment or executing a CHO/LTM) based on RLF prediction, but use the prediction to get prepared for a better recovery if and/or when the RLF actually occurs later. In some examples, how to prepare the WTRU for a faster recovery from radio link failures based on RLF predictions may be implemented.

### SUMMARY

A wireless transmit/receive unit (WTRU) may comprise a processor. The processor may be configured to send capability information related to radio link failure (RLF) prediction based on an artificial intelligence (AI)/machine learning (ML) model. The processor may be configured to receive configuration information associated with radio link monitoring (RLM) and RLF detection and prediction. The configuration information may include, for example, an early synchronization configuration associated with a target cell for RLF recovery. The processor may be configured to predict radio link failure of a serving cell of the WTRU at a predicted RLF time. The processor may be configured to perform early synchronization with the target cell based on the early synchronization configuration. The processor may be configured to detect a RLF of the serving cell at the predicted RLF time or within a time window that includes the predicted RFL time. The processor may be configured to perform a recovery of a connection via the target cell. The capability information may be sent and the configuration information may be received, for example, via the serving cell.

The early synchronization configuration may include, for example, a plurality of random access channel (RACH) preambles. Each RACH preamble of the plurality of RACH preambles may be associated with a respective predicted RLF time.

To perform the early synchronization with the target cell, the processor may be configured to send a RACH preamble associated with the predicted RLF time to the target cell. The processor may be configured to receive a random access response (RAR) from the target cell, wherein the RAR may include, for example, a timing advance (TA) and an uplink (UL) grant information associated with the target cell.

The processor may be configured to apply the received TA for subsequent UL transmissions towards the target cell. The processor may be configured to perform a radio resource control (RRC) re-establishment to perform the recovery of the connection via the target cell. The processor may be configured to send an RRC re-establishment request message to the target cell using resources indicated in the UL grant information, and receive an RRC re-establishment message from the target cell.

The RRC re-establishment request message may include, for example, one or more of cell radio network temporary identifier (C-RNTI), physical channel identity (PCI), and/or security integrity information derived based on security configuration at the serving cell.

To perform the recovery of the connection via the target cell, the processor may be configured to receive a conditional handover (CHO) configuration corresponding with the target cell. The processor may be configured to send a CHO complete message to the target cell using resources indicated in the UL grant information.

A WTRU may be configured to perform a method that includes one or more of the following steps. The method may include sending capability information related to radio link failure (RLF) prediction based on an artificial intelligence (AI)/machine learning (ML) model. The method may include receiving configuration information associated with radio link monitoring (RLM) and RLF detection and prediction. The configuration information may include, for example, an early synchronization configuration associated with a target cell for RLF recovery. The method may include predicting radio link failure of a serving cell of the WTRU at a predicted RLF time. The method may include performing early synchronization with the target cell based on the early synchronization configuration. The method may include detecting a RLF of the serving cell at the predicted RLF time or within a time window that includes the predicted RFL time. The method may include performing a recovery of a connection via the target cell. The capability information may be sent and the configuration information may be received, for example, via the serving cell.

The early synchronization configuration may include, for example, a plurality of random access channel (RACH) preambles. Each RACH preamble of the plurality of RACH preambles may be associated with a respective predicted RLF time.

To perform the early synchronization with the target cell, the method may include sending a RACH preamble associated with the predicted RLF time to the target cell. The method may include receiving a random access response (RAR) from the target cell, wherein the RAR may include, for example, a timing advance (TA) and an uplink (UL) grant information associated with the target cell.

The method may include applying the received TA for subsequent UL transmissions towards the target cell. The method may include performing a radio resource control (RRC) re-establishment to perform the recovery of the connection via the target cell. The method may include sending an RRC re-establishment request message to the target cell using resources indicated in the UL grant information, and receiving an RRC re-establishment message from the target cell.

The RRC re-establishment request message may include, for example, one or more of cell radio network temporary identifier (C-RNTI), physical channel identity (PCI), and/or security integrity information derived based on security configuration at the serving cell.

To perform the recovery of the connection via the target cell, the method may include receiving a conditional handover (CHO) configuration corresponding with the target cell. The method may include sending a CHO complete message to the target cell using resources indicated in the UL grant information.

A wireless transmit/receive unit (WTRU) may comprise a processor. The processor may be configured to send capability information related to radio link failure (RLF) prediction based on an artificial intelligence (AI)/machine learning (ML) model. The processor may be configured to receive configuration information associated with radio link monitoring (RLM) and RLF detection and prediction, wherein the configuration information comprises an early synchronization configuration associated with a target cell for RLF recovery. The processor may be configured to receive a random access response (RAR) from the target that includes a timing advance (TA) and indication of at least one uplink (UL) grant information. The processor may be configured to predict radio link failure of a serving cell of the WTRU at a predicted RLF time. The processor may be configured to perform early synchronization with the target cell based on the early synchronization configuration. The processor may be configured to determine that RLF did not occur. The processor may be configured to send an indication to the target cell that RLF did not occur so that target cell can release the uplink (UL) grant.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example radio link monitoring (RLM) and radio link failure (RLF) detection and/or recovery procedure according to an embodiment.

FIG. 3 is a system diagram illustrating an example radio resource control (RRC) re-establishment procedure according to an embodiment.

FIG. 4 is a system diagram illustrating an example L1/L2 triggered mobility (LTM) procedure according to an embodiment.

FIG. 5 is a flowchart illustrating an example procedure for performing RACH-less recovery according to an embodiment.

### DETAILED DESCRIPTION

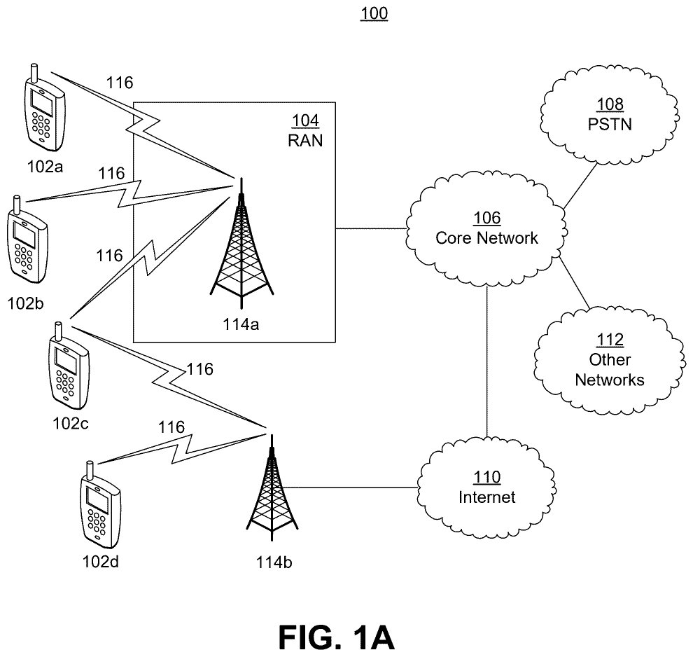

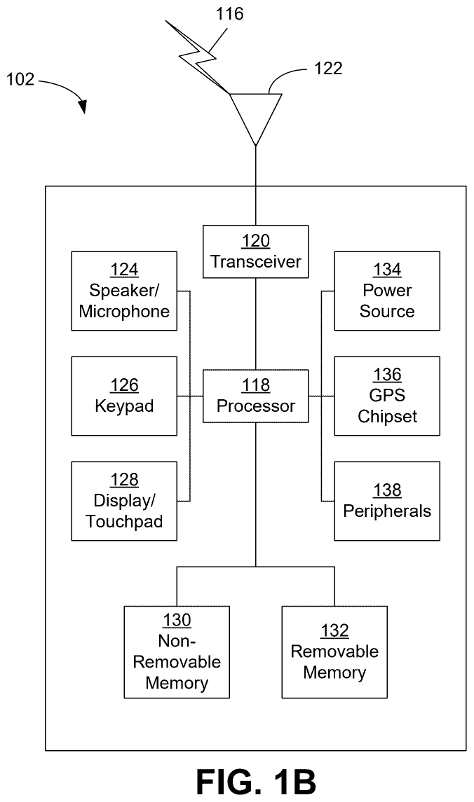

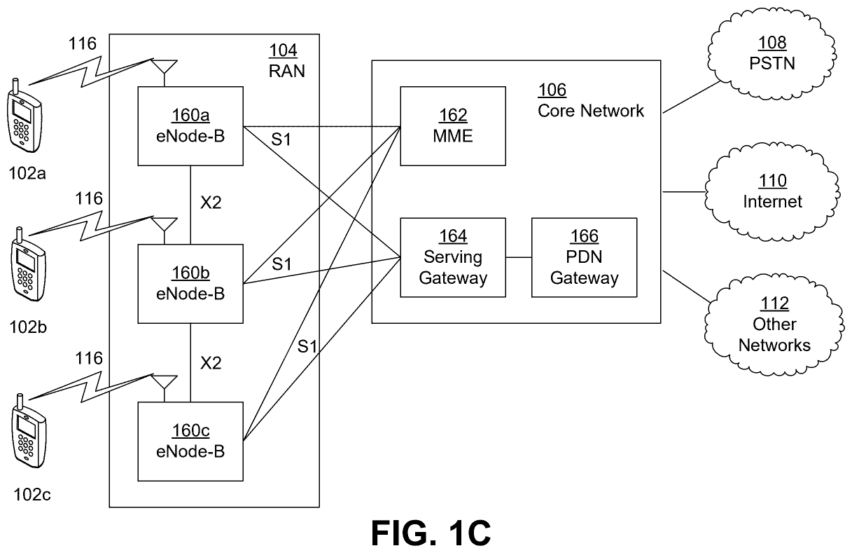

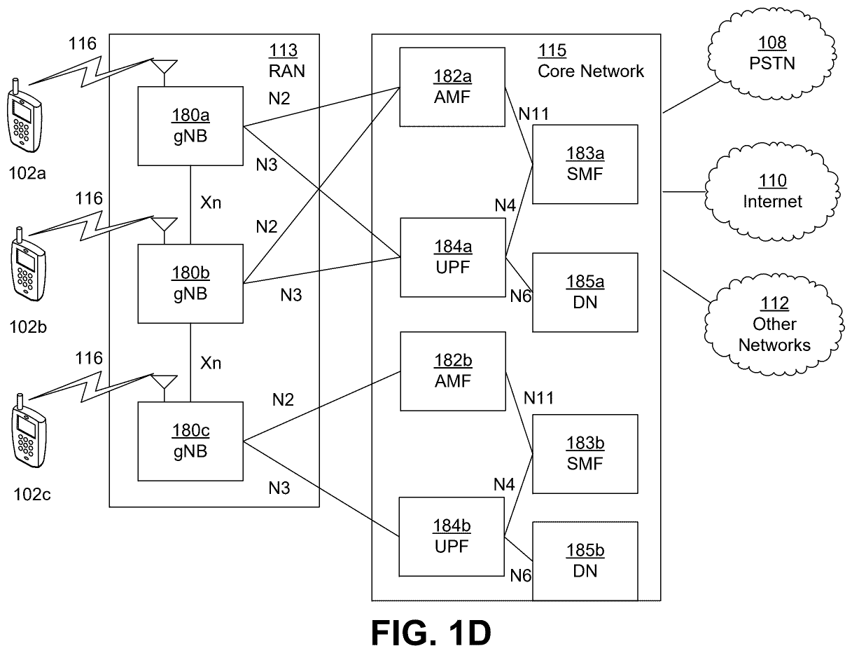

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be configured to trigger an early synchronization (sync) with a target cell upon a prediction of radio link failure (RLF) (e.g., initiating a random access (RA) towards a target cell). A WTRU may be configured to use different random access channel (RACH) preambles for the early sync depending on the anticipated time of the RLF. A WTRU may be configured to receive a random access response (RAR) from the target that includes a timing advance and indication of at least one uplink (UL) grant information that is to be used later for sending subsequent recovery message if and/or when RLF gets detected. A WTRU may be configured to receive information about a (short) UL grant (e.g., in the RAR) that can be used to indicate error information (e.g., RLF didn't happen as expected and UL grant for the subsequent recovery can be released). A WTRU may be configured to use the UL grant provided in the RAR to initiate a recovery (e.g., re-establishment, conditional handover (CHO), L1/L2 triggered mobility (LTM), etc.) when and/or if RLF happens (e.g., within a given window of the predicted time for RLF, before the time of the UL grant for subsequent recovery message, etc.). A WTRU may be configured to send error and/or cancellation information to the network, indicating that RLF didn't happen as predicted (or is no more expected to happen), before the time for the UL grant for subsequent UL message (e.g., using the short grant indicated to be use for such purposes during the early sync).

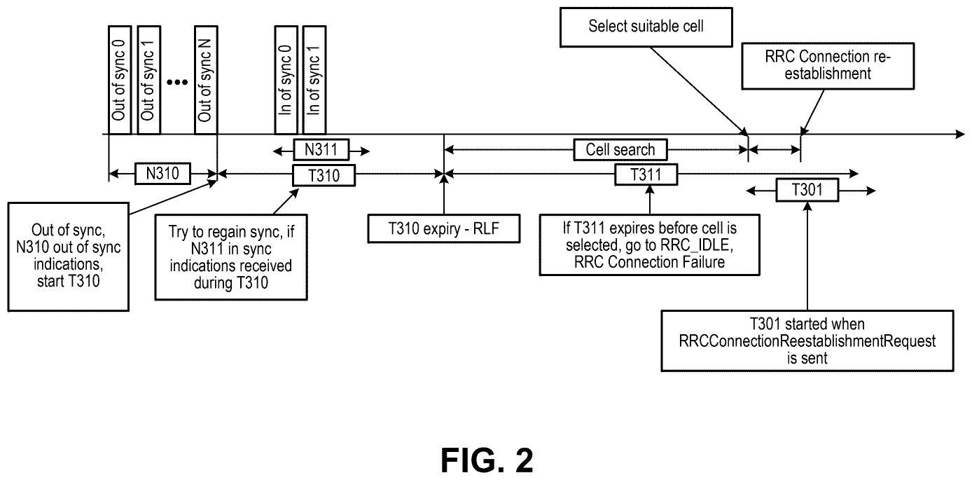

Radio link monitoring and radio link failure may be implemented. While in RRC_CONNECTED state, the WTRU may perform Radio Link Monitoring (RLM) on the serving cell (e.g., the primary cell in the case of multiple cells configured for carrier aggregation). The WTRU may be configured with timers and counters to use when detecting Radio Link Failure (RLF) and performing radio link recovery and/or re-establishment. The physical layer (PHY) sends out of sync (OOS) and in sync (IS) indications to the RRC, based on whether the serving cell's signal-to-interference plus noise ratio (SINR) is below or above a configured SINR threshold. For example, as shown in FIG. 2, upon the detection of N310 consecutive OOS indications from PHY, the RRC starts a timer with a duration of T310. While T310 is running, the WTRU attempts to recover the radio link on the serving cell. If N311 consecutive IS indications are received at RRC from PHY, then the timer is stopped, and the WTRU considers the radio link to have been recovered and resumes normal operation and continues RLM on the serving cell. If T310 expires before the N311 consecutive IS indications are received, then the WTRU considers this as an RLF. Upon detection of RLF, a timer is started with the duration of T311, and the WTRU performs a cell search in order to determine whether there is a suitable cell available on which the WTRU may perform RRC connection re-establishment. If the timer T311 expires before the WTRU finds a suitable cell, then the WTRU enters RRC_IDLE mode with the cause “RRC Connection failure”. If the WTRU does find a suitable cell (e.g., which could be the original serving cell), then this suitable cell is selected, T311 is stopped, T301 is started, and an RRC Connection re-establishment procedure is started. If the timer T301 expires before the RRC Connection re-establishment is complete, then the WTRU enters idle mode with the cause “RRC Connection failure”.

A RLF may occur, for example, when the WTRU goes out of coverage (e.g. entering a tunnel and/or moving to a rural area out of cellular coverage). An RLF may occur, for example, as a result of too late of a handover, whereby RLF is detected on the serving cell before a handover can be completed. The first part of the procedure (N310, T310, N311) is intended to allow the WTRU a chance to recover the radio link in case of a temporary problem. The second part of the procedure after T310 expiry is intended to allow the WTRU to attempt to re-establish the connection on the same or another cell without having to release the connection completely. See FIG. 2 which summarizes an example of RLM and RLF detection procedures.

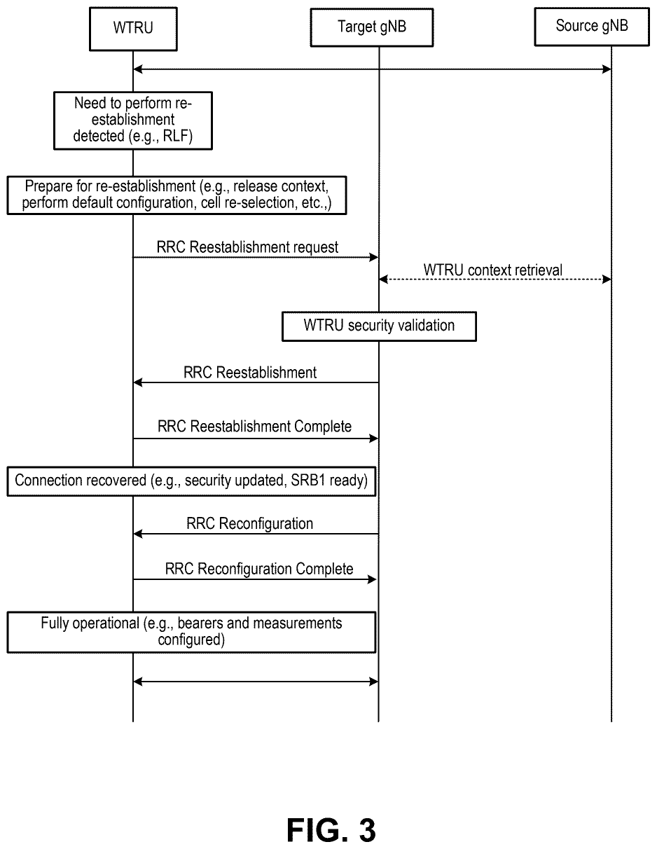

RRC re-establishment may be implemented. Upon detecting an RLF (e.g., as described above and herein), the WTRU performs an RRC re-establishment to recover the radio link. FIG. 3 provides an example high-level overview of the re-establishment procedure. During the re-establishment procedure, the WTRU may perform several functions. For example, the WTRU may reset the medium access control (MAC). The WTRU may release the WTRU configuration and/or context, including security configuration. The WTRU may perform cell re-selection (e.g., select the cell with the best radio quality the WTRU can measure at the time). The WTRU may perform random access to the target to get the timing advance (TA) for UL communications and to get the UL grant for sending the re-establishment request message (e.g., the WTRU may send a random access preamble, called msg1, and may receive a random access response (RAR) that contains the TA and the UL grant). The WTRU may apply default configurations and send an RRC re-establishment request message to the network. This message may include information such as the identity of the WTRU (e.g., cell radio network temporary identifier (C-RNTI)) at the source cell where the re-establishment was triggered, the physical channel identity (PCI) of the source cell, security integrity information that is derived based on the security configuration that was used at the source cell, and/or the cause of the re-establishment (e.g., RLF, integrity verification failure, reconfiguration failure, etc.).

In some examples, the network may use the security information included in the re-establishment request to verify the request is from a legitimate WTRU and recover the latest WTRU context and/or configuration using the provided WTRU identity and source cell identity (e.g., if the WTRU is re-establishing at a target cell different from the source cell and the target cell is served by a gNB that is different from the gNB serving the source cell, the target gNB may request the WTRU context and/or configuration information from the source). The network may send the WTRU an RRC re-establishment message, which includes information for the WTRU to update the security context. Signaling radio bearer (SRB1) may be now up and running and the network may send an RRC reconfiguration message to the WTRU to finalize the recovery (e.g., provide new WTRU identity, setup the bearers, configure measurements, etc.). The configuration of the WTRU identity, the bearers, measurements, etc., may be the same as that was used in the source cell before the re-establishment was triggered or it could be different (e.g., another WTRU at the target is already using the identity, not all the bearers can be admitted at the target, some measurement configuration may have to be modified due to the target's capability/configuration, etc.).

In some examples, the concept of conditional reconfiguration was introduced, where the WTRU may be provided with an RRC reconfiguration (e.g., a handover (HO) command) that is executed when certain measurement conditions are fulfilled (e.g., neighbor cell becomes better than the serving cell by more than a certain threshold). For example, instead of the legacy way of the WTRU sending a measurement report and the network sending a HO command, the HO command is already prepared and sent to the WTRU, and the WTRU may execute this already stored HO command when the measurement conditions are fulfilled. Conditional reconfiguration, as it is normally associated with HOs, it is usually referred to as CHO (conditional HO). In order to ensure the CHO works, the network has to ensure the target is already prepared (e.g., has been provided with the WTRU context and/or configuration, admitted the bearers, etc.). Also, the actual HO command (i.e., RRC reconfiguration message containing a reconfiguration with sync message) may be prepared by the target and just forwarded via the source to the WTRU.

In some examples, if the WTRU is configured with conditional reconfiguration, the WTRU may perform a slightly enhanced re-establishment procedure. The WTRU may not release its context and/or configuration at the start of the re-establishment procedure, but may determine if the cell re-selection procedure results in a selecting a cell that is a CHO target (e.g., WTRU already has a CHO stored for that target and target is already prepared for the WTRU). If so, there is no need to continue with the re-establishment procedure and the WTRU just executes the associated CHO command.

In some examples, the re-establishment procedure may not succeed due to several reasons. For example, the re-establishment procedure may not succeed due to the WTRU not being able to perform cell re-selection within a given time (e.g., timer T311, which is started when the WTRU starts the cell re-selection procedure expires before the WTRU has found a suitable cell to re-establish to). The re-establishment procedure may not succeed due to the WTRU not being able to find a suitable cell but the cell became not suitable anymore before the re-establishment procedure is completed. The re-establishment procedure may not succeed due to the WTRU not receiving the re-establishment message from the network within a given time after sending the re-establishment request (e.g., timer T301, which is started when the WTRU sends the re-establishment request expires before the reception of the re-establishment command from the network).

In these cases, the WTRU may be forced to go to RRC_IDLE mode and a recovery via connection setup from scratch may be triggered by the WTRU, which is an even lengthy procedure than the re-establishment as there is no radio access network (RAN) level context fetching and the core network (CN) has to be involved in setting up and/or configuring the bearers. A similar recovery from scratch may be performed (e.g., this time triggered by the network), if the WTRU context was not retrieved properly upon the reception of the re-establishment request.

Mobility in new radio (NR) may be implemented. LTM was standardized, wherein the WTRU is pre-configured, like in the case of conditional handover (CHO), with RRC reconfiguration to apply upon switching (e.g., being handed over) from a source cell to a target cell, but does the switching and/or handover upon receiving a medium access control-control element (MAC-CE) (e.g., referred to as an LTE cell switch command) indicating the cell switch (e.g., instead of autonomous handover in the case of CHO based on the fulfillment of measurement events). LTM offers improvements in handover latency and interruption time compared to Layer 3 based mobility.

One aspect that may improve the latency of LTM is the possibility of performing early synchronization (e.g., early timing advance (TA), acquisition). For example, based on L1/L2 measurements the WTRU is sending, the network may anticipate that the WTRU may need to be switched to a particular candidate cell and it can configure the WTRU to do the early TA acquisition (e.g., by sending a physical downlink control channel (PDCCH) order). The WTRU may send a RA preamble to the indicated candidate cell. The target, instead of sending a Random Access Response (RAR) message that includes the TA to the WTRU, may send the TA value to the source cell. Later, if the source decides the WTRU to switch to the candidate cell, the source will include the TA value in the LTE cell switch command (e.g., the WTRU doesn't need to perform RA procedure to execute the switching to the target and may directly send the HO complete message to the target). This process is referred to us RACH-less LTM.

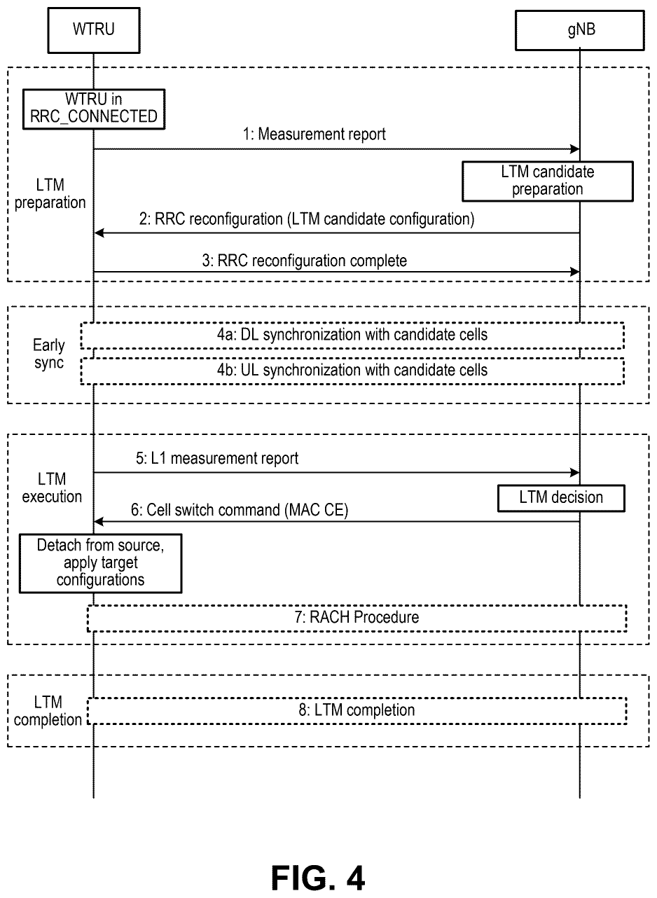

Similar to the CHO case, a cell configured for LTM may be used also for recovery from RLF (e.g., if the WTRU detects RLF and performs a cell selection to a cell that is already configured for LTM, then it will execute this LTM configuration instead of doing the re-establishment). FIG. 4 provides an example LTM procedure as discussed above and herein.

Artificial Intelligence and Machine Learning (AI/ML) for NR may be implemented. A study item on AI/ML mobility enhancements has been executed, with the main objective of studying enhancements for network triggered L3-based handover (e.g., handover triggered by the network based on information received by the WTRU, such as measurement reports). In some examples, enhancements based on RLF and handover failure (HOF) predictions are also being studied.

Methods for early synchronization with candidate target cells based on radio link failure prediction, to enable faster recovery if and/or when the radio link failure occurs may be implemented. In some examples, a WTRU may send capability information related to radio link failure detection (e.g., based on an AI/ML model). A WTRU may receive a configuration of radio link monitoring (RLM) and/or radio link failure (RLF) detection and prediction parameters (e.g., based on the capability the WTRU has indicated), where the configuration may include configuration for early synchronization with a target cell for RLF recovery (e.g., one or more RACH pre-ambles, each associated with RLF prediction time horizon). A WTRU may perform the radio link monitoring and radio link failure detection and prediction.

In some examples, upon predicting that a radio link failure (e.g., t+Δt, where t is the current time), the WTRU may perform one or more of the following. For example, the WTRU may determine the target cell for recovery (e.g. cell with the strongest signal level, based on current measurements and/or predicted measurement at t+Δt). The WTRU may perform early sync with the determined target. For instance, the WTRU may send a RACH preamble to the target cell (e.g., select a RACH pre-amble, among the preconfigured preambles, corresponding with Δt). For instance, the WTRU may receive a RAR from the target cell, containing the TA and UL grant information (e.g., frequency/time resources for the UL grant to send a msg3).

In some examples, upon detecting an RLF at the predicted RLF time and/or within a configured time window of the predicted time, and if the target cell has an associated LTM/CHO configuration, the WTRU may perform a RACH-less LTM/CHO using the LTM/CHO configuration corresponding with the target (e.g., send the HO complete message to the target using the TA previously acquired and received UL grant in the RAR). In some examples, alternatively the WTRU may perform a RACH-less re-establishment procedure to the prepared target cell (e.g., send the RRC re-establishment request message to the target using the TA previously acquired and received UL grant in the RAR, and follow legacy procedure afterwards).

In some examples, upon determining that RLF didn't occur (e.g., the prediction was wrong) and/or predicting that it is no more expected to occur at the predicted time (e.g., within a given time window of the predicted RLF time), the WTRU may send an indication to the network (e.g., source cell, target cell), indicating that RLF did not occur and/or is not expected to occur (e.g., so that target can use the configured UL grant for other WTRUs).

By performing an early sync to a target cell based on RLF prediction, the recovery and/or interruption time from radio link failures may be reduced (e.g., WTRU doesn't need to do RA procedure if and/or when RLF gets detected).

Artificial intelligence (AI) may be broadly defined as the behavior exhibited by machines. Such behavior may, for example, mimic cognitive functions to sense, reason, adapt and act. Machine learning (ML) may refer to type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning (DL) refers to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, for example, speech, vision, natural language etc. and for various machine learning settings supervised, un-supervised, and semi-supervised. The term AI/ML based methods and/or processing may refer to realization of behaviors and/or conformance to requirements by learning based on data, without explicit configuration of sequence of steps of actions. Such methods may enable learning complex behaviors which might be difficult to specify and/or implement when using legacy methods.

A given AI/ML model may be trained under certain WTRU and network side additional conditions. For example, a WTRU side condition could be the speed of the WTRU. On the other hand, network side additional conditions could be something that may be related to some network configurations and/or settings that the WTRU may not be aware of but may impact the performance of the model. For example, an RLF prediction model may perform differently if it is trained when the network was using a certain antenna pattern, beam pattern, power levels, and so on. Also, there could be aspects related to network load, that may have impact on the model performance.

Since the WTRU doesn't necessarily need to know all the details of the network side additional conditions, and network may also not want to expose some of these implementations, the network may hide these details by signaling to the WTRU one or more associated ID(s). For example, when data is being collected for training a model, tagging may be performed indicating under which network side additional conditions the model is being trained. When a WTRU is being configured to perform the AI/ML based RLF prediction, it may be configured to check the consistency between the conditions under which the AI/ML model is trained on and/or current conditions (e.g., current WTRU conditions, current associated ID(s) signaled by the network indicating current network conditions/settings, etc.).

In some examples discussed herein, it may be assumed that the WTRU will be performing the AI/ML based RLF prediction only if it has an AI/ML model that is applicable to the current WTRU and network side additional conditions. For example, the network may have communicated the current associated ID(s), and WTRU has indicated that it has a model that works under the current WTRU conditions and associated ID(s), and based on that the network has activated the AI/ML functionality at the WTRU. In case the applicability changes while the functionality is being used, the WTRU may be configured to stop the AI/ML functionality and start using legacy procedures (e.g., WTRU informing change of applicability to the network and network deactivating the functionality, WTRU autonomously deactivating the functionality when it determines applicability has changed, etc.). The applicability change may be due to the change in WTRU side conditions such as speed changes and the WTRU has no model trained for those conditions, and/or the associated ID changes and WTRU has no model trained for the new associated ID, where the associated ID change could be due to the WTRU performing a HO to a cell that is operating under different network conditions, and/or the network changing some of its configurations without the WTRU performing a HO, etc.

The term life cycle management (LCM) is used to describe the overall management aspects of AI/ML models, such as model training, functionality/model identification, model delivery/transfer, and/or model inference operation. LCM may include functionality/model selection, activation, deactivation, switching, and fallback operation. Functionality/model selection, activation, deactivation, switching, and fallback operation may include decisions by the network (e.g., either network initiated or WTRU-initiated and requested to the network), and/or decisions by the WTRU (e.g., event-triggered as configured by the network, WTRU's decision reported to the network, or WTRU-autonomous either with WTRU's decision reported to the network or without it). LCM may include functionality/model monitoring, model update, WTRU capability, and/or data collection (e.g., for model training, for monitoring, for inference, etc.).

In some examples, LCM can be functionality-based LCM or model-ID based LCM. In functionality-based LCM, the network indicates activation/deactivation/fallback/switching of AI/ML functionality via signaling (e.g., RRC, MAC-CE, downlink control information (DCI)). Models may not be identified at the network, and the WTRU may perform model-level LCM. The WTRU may have one AI/ML model for the functionality, and/or the WTRU may have multiple AI/ML models for the functionality. In model-ID-based LCM, models are identified at the network, and network and/or WTRU may activate/deactivate/select/switch individual AI/ML models via model ID.

In the functionality-based LCM, the WTRU may choose the AI/ML model to use for a certain functionality (e.g., network decides for which functionalities the WTRU can use AI/ML based operation, and the WTRU chooses the AI/ML model to use). In the model-ID based LCM, the network may explicitly control which particular model is used for a given AI/ML functionality. For example, the WTRU provides details of AI/ML models and their capabilities, network determines which model to activate for a particular functionality.

In some examples, the discussed methods may be applicable to both model-ID based and functionality-based LCM. The solutions may be related to how the WTRU determines whether it has a model that is applicable for the indicated associated ID(s). For example, in the case of functionality-based LCM, the WTRU may be configured and/or requested to determine if a given functionality is valid and/or applicable, and it may do the determination among all the models it has for a given functionality and may consider the functionality applicable if at least one of the models is applicable. In another example, in the case of model-ID based LCM, the WTRU may be configured and/or requested by the network to determine whether a particular model is applicable or not.

The WTRU may support several AI/ML models for a given functionality (e.g., with different prediction time horizons, prediction confidence levels, processing requirements, trained under/for operation in different frequencies/cells/location/times of day, etc.). A given AI/ML model for a certain functionality may operate in different modes (e.g., with different levels of prediction confidence levels at different prediction time horizons, at different locations, frequencies, WTRU mobility pattern/speed, etc.). The AI/ML models can be available at the WTRU already trained, and/or the WTRU may be provided with an untrained AI/ML model and performs the training by itself. The AI/ML model may be available at the WTRU already trained, and the WTRU may be enabled and/or configured to perform further training (e.g., for different conditions such as frequencies/cells/location/times of day, for the same conditions as the initial training but for increasing the level of confidence or/and the prediction time horizon, for different WTRU speeds, etc.). The AI/ML model may be available at the WTRU but not trained at all or only trained for certain WTRU and/or network conditions, and WTRU may be configured to train the model (e.g. for the conditions that it is not trained for).

In some examples, the WTRU may require some configurations and/or inputs that it needs for performing the inference using an AI/ML model. For example, for RLF prediction, the WTRU may need to be configured with a certain number of beams and/or cells to measure to determine the prediction. In some cases, the WTRU may communicate the required configuration and/or input as part of the capability information. In some examples, the required configuration and/or input may be communicated to the network after capability request (e.g., based on explicit network request, if the WTRU gets configured to do AI/ML based RLF predictions, and it has determined that it is lacking the required configuration/input, etc.).

All the examples described herein are agnostic to the kind of AI/ML model and/or technique used by the WTRU (e.g., the algorithm used, the mechanism such as neural network or what kind of neural network, e.g., depth and parameters/weights of the network, etc.), the origins of the model (e.g., WTRU vendor, operator, network vendor, etc.), or how and/or where the training of the model is done (e.g., the input data used for the training, where the training is performed, if the training is performed offline or online, etc.). However, it can be assumed that the model is trained based on historical observation of one or more WTRUs' actual measurements in different WTRU and network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU just as a network configuration index that is provided by the network at the time of training or data collection for the training, etc.).

The terms AI/ML and AIML may be used interchangeably. The terms “data”, “measurements”, “report” and “results” may be used interchangeably. The terms indication, information and message may be used interchangeably. The terms “current cell”, “serving cell”, and “source cell” may be used interchangeably. The terms “target cell” and “candidate cell” may be used interchangeably. The terms “handover” and “cell switching” may be used interchangeably. The terms functionality and procedure may be used interchangeably. The terms “execute”, “apply” and “perform” may be used interchangeably. The terms “send recovery message” and “initiate recovery” may be used interchangeably (e.g., to indicate the WTRU sending the re-establishment request and/or the HO complete message). The terms legacy and non-AI/ML may be used interchangeably.

Though the focus of the example descriptions below and herein are on prediction based on AI/ML models, the example methods are equally applicable to any other form of prediction that doesn't use AI/ML (e.g. time series forecasting, interpolation methods, etc.).

WTRU capability and related aspects may be implemented. In some examples, the WTRU may send its RLF prediction related capability to the network (e.g., based on explicit request from the network, proactively by the WTRU, etc.). The capability, for example, may indicate the supported AI/ML models and/or functions by the WTRU, confidence level of predictions, time horizon of predictions (e.g., how far along in the future are the prediction being made), and/or other conditions under which the functions and/or models work (e.g., network side additional conditions, WTRU side additional conditions, time of day, locations, for example, cells/global navigation satellite systems (GNSS) co-ordinates, etc.).

In some examples, the WTRU may send its capability related to mobility (e.g., LTM, CHO, etc.) to the network (e.g., based on explicit request from the network, proactively by the WTRU, etc.). The capability, for example, may indicate if the WTRU supports LTM, and/or if the WTRU supports early sync (e.g., based on a reception of a PDCCH order and sending of a RACH preamble), etc.

In some examples, the WTRU may perform an indirect RLF prediction, wherein the AI/ML model may first predict a time series of SINR values of the serving cell in the future, and this may be used on the legacy RLF detection procedure (e.g., in FIG. 2 the occurrence of N310 consecutive out of syncs and then the expiry of the T310 before N311 consecutive in-syncs), to derive the expected time of an RLF.

In some examples, the WTRU may perform a direct RLF prediction, wherein the AI/ML model may provide a prediction of the probability of an RLF happening within a time window in the future (e.g., without the need to do the intermediate prediction of the SINR).

In some examples, if the WTRU supports indirect RLF prediction, the WTRU may further indicate to the network further capability regarding the margin of window for the predicted RLF prediction (e.g., as it will be very unlikely that the predicted RLF will occur exactly at a given time, even if the model is very accurate). For example, the WTRU may indicate a margin of error window length and/or duration of +/−X milliseconds (ms). That means, when the WTRU predicts an RLF to occur at time t1, the WTRU expects the RLF to occur between t1−X and t1+X. Alternatively and/or additionally, the WTRU may expect a different margin for the lower and upper window (e.g., RLF predicted to occur at t1 indicates that the RLF is expected to occur between t1−X1 and t1+X2).

In some examples, the WTRU may indicate to the network whether it supports direct RLF prediction, indirect RLF prediction and/or both. In some examples, if the WTRU supports both direct and indirect RLF prediction, the WTRU may be left to WTRU implementation to decide which RLF prediction and corresponding model to apply. In some examples, the network may configure the WTRU to perform the prediction using direct or indirect prediction models.

Configurations and behavior related to the RLF prediction may be implemented. As described above, herein and in FIG. 2, the RLF detection procedure consists of two phases, phase 1 and phase 2. Phase 1 consists of detection of radio link problem (e.g., N310 consecutive OOSs). Phase 2 consists of detection if recovery happens or doesn't happen within T310 after radio link problem was detected in phase 1 (e.g., no N311 consecutive OOSs are observed during the T310). In some examples, the WTRU may have a model that is concerned about only phase 1. For example, the WTRU may have a model that will predict when T310 timer is expected to start (e.g., with more than a given confidence level). In some examples, the WTRU may have a model that is concerned about only phase 2. For example, the WTRU may have a model that can be used after T310 has started (e.g., the N310 consecutive OOSs have already been detected) to predict whether the T310 will expire before the required N311 consecutive ISs are detected. In some examples, the WTRU may have a model that is concerned about both phase 1 and phase 2. For example, the WTRU may have a model that can be used to predict both the start time of the T310 and whether there will be recovery or not after that.

The WTRU may have different models for predicting phase 1 and phase 2. This may be applicable for both direct and indirect prediction. In some examples, the WTRU may be configured to predict the occurrence of a certain number of consecutive OOSs (e.g., n1, where n1=N310, n1<N310, n1>N310, etc.) and consider phase 1 is predicted when the configured number of OOSs have been predicted to occur (e.g., within a given time from the current time, with a confidence level above a certain configured threshold).

In some examples, the WTRU may be configured to consider phase 1 is predicted when a certain number consecutive OOSs (e.g., n1) have already been detected and a certain number of consecutive OOSs (e.g., n2) are predicted to occur (e.g., within a given time from the current time, with a confidence level above a certain configured threshold). For example, n1 and n2 may be configured as independent numbers and/or relative to each other. For example, the WTRU may be configured with the total of the two (e.g., n1+n2) and may determine the phase 1 is predicted when the number of actual detected consecutive OOSs and the predicted ones is equal to n1+n2 (e.g., actual=n 3, predicted=(n1+n2)−n3, where n3 is any number between 0 and n1+n2).

In some examples, the WTRU may be configured to predict the occurrence of a certain number of consecutive ISs (e.g., n1, where n1=N311, n1<N311, n1>N311, etc.) after T310 has started and consider recovery is predicted (e.g., no RLF predicted) if it predicts that n1 consecutive ISs are predicted to occur (e.g., before the T310 expiry, for example, within a certain confidence level), or otherwise consider there will be an RLF.

In some examples, the WTRU may be configured to consider recovery is predicted when a certain number consecutive ISs (e.g., n1) have already been detected after T310 has started and a certain number of consecutive ISs (e.g., n2) are predicted to occur (e.g., before the T310 expiry, with a confidence level above a certain configured threshold). For example, n1 and n2 can be configured as independent numbers or relative to each other. For example, the WTRU may be configured with the total of the two (e.g., n1+n2) and may predict that RLF will not be detected (e.g. recovery during phase 2) when the number of actual detected consecutive ISs and the predicted ones is equal to n1+n2, before the T310 expiry (e.g., actual=n3, predicted=(n1+n2)−n3, where n3 is any number between 0 and n1+n2).

In some examples, the WTRU may be configured to do the prediction of RLF or not RLF without splitting it into phase 1 and phase 2 considerations. For example, the WTRU may be configured with n1 (e.g., related to N310) and n2 (e.g., related to N311) and T310, and may directly predict if the RLF is expected to occur at a certain time in the future (e.g., delta_T from the current time).

The configuration of the parameters described above and herein may be dependent on confidence levels. For example, the WTRU may be configured with a multitude of n1 and n2 parameters that were discussed above for the OOSs and ISs (e.g., n1_1, n1_2, n1_3, etc., each associated with different confidence levels of the prediction). For example, the WTRU may be configured to consider phase 1 detection if n1_1 OOSs are predicted to occur with a confidence level c1, n1_2 OOSs are predicted to occur with a confidence level between c1 and c2, and so on.

Instead of considering consecutive OOSs and ISs, the WTRU may be configured to consider a total number of OOSs and ISs for the RLF prediction. For example, the WTRU may be configured to consider that phase 1 will be detected if n1_1 consecutive OOSs are predicted or if n1_2 OOSs (e.g., consecutive or not) are predicted to occur within a given time (e.g., 10 consecutive OSSs and/or 15 not-necessarily consecutive OSSs within a given configured duration). The WTRU may be configured to consider the radio link to be recovered if n2_1 consecutive ISs are predicted before T310 expiry or if n2_2 ISs (e.g., consecutive or not) are predicted before the T310 expiry (e.g., 10 consecutive ISs, or 15 not necessarily consecutive ISs before T310 expiry).

When to perform the early sync may be implemented. In some examples, the WTRU may be configured to perform the early sync to a candidate cell when it has made a prediction about phase 1 with a confidence level above a given confidence level threshold (e.g., if the WTRU predicts that N310 consecutive OOSs will be detected at time t1 from now with a confidence level of above the threshold, regardless of the time t1). In some examples, the WTRU may be configured to perform the early sync when it has made the prediction about phase 1 and the time for the expected start of T310 is below a certain configured time duration threshold. The WTRU may be configured to perform the early sync when it has made the prediction about phase 1 with a confidence level above a given confidence level threshold and the time for the expected start of T310 is below a certain configured time duration threshold. The WTRU may be configured to perform the early sync a certain configured time duration before the expected time of the RLF.

In some examples, the WTRU may be configured to perform the early sync within a given time window, where the time window length is dependent on the prediction. For example, if the WTRU was using an indirect prediction that gives a predict time of occurrence for the RLF and some error margin window (e.g., +/−X ms), the WTRU may be configured to perform the early sync not earlier than the t1−X and not later than t1+X, where t1 is the predicted time for the RLF. In another example, if the WTRU is using a direct RLF prediction model (e.g., RLF expected to occur between t1 and t2), then the WTRU may be configured to perform the early sync not earlier than t1 and not later than t2. In some examples, the WTRU may consider an even shorter window for the early sync as compared to the predicted RLF window. In the previous example of direct prediction (RLF predicted between t1 and t2), the WTRU may be configured to do the early sync between t3 and t4, where t1<=t3<=t4<=t2. The values of t3 and t4 may be explicit and/or they may be relative to the values of t1 and t2 and/or the difference between the two. For example, if the difference between t1 and t2 was 600 ms, the WTRU may be configured to perform the early sync at sometime between t1+150 ms and t1+450 ms (i.e., the inner half of the time window of the prediction).

Selecting the cell for early sync may be implemented. In some examples, the WTRU may be configured to perform early sync to the strongest neighbor cell. The WTRU may be configured to perform early sync to the strongest neighbor cell operating at the same frequency as the current serving cell. The WTRU may be configured to perform early sync to the strongest neighbor cell, among the cells configured for CHO/LTM. The WTRU may be configured to perform early sync to a CHO/LTM candidate cell only if that cell has a signal level above a certain configured threshold. The WTRU may be configured to perform early sync to a CHO/LTM candidate cell only if that cell has a signal level stronger than the current cell by more than a certain configured threshold. The WTRU may be configured to perform early sync to a CHO/LTM candidate cell only if the signal level of the current cell is not better than the candidate cell by more than a certain configured threshold. The WTRU may be configured to perform early sync to a CHO/LTM candidate cell only if the signal level of the strongest neighbor cell is not better than the candidate cell by more than a certain configured threshold.

In some examples, the WTRU may be (e.g., explicitly) configured with a set of candidate cells for which the early sync is allowed. Possibly such a set of candidate cells may be a subset of all configured CHO/LTM candidate cells. The WTRU may perform early sync only if the target cell is a part of configured subset. The WTRU may perform legacy re-establishment procedure if the target cell is not a part of configured subset.

Variations of the above examples may be envisioned where the WTRU considers not only current measurements but also predicted measurement of the serving and/or neighbor cell for determining the target cell. For example, the WTRU may be configured to determine the target cell to be the cell whose signal level is expected to be the strongest at the time RLF is predicted (e.g., even though that cell may not be the strongest at the time of the prediction). For example, the WTRU may be configured to consider a CHO/LTM candidate cell to perform early sync to if the signal level of that cell is expected to be above a certain configured threshold (e.g., or not worse than the strongest serving cell by more than a certain configured threshold) at the time RLF is predicted.

Aspects related to RA for early sync may be implemented. In some examples, the WTRU may obtain the information related to the RACH occasions for sending the RA to the target cell from the source cell. In some examples, the WTRU may obtain the information related to the RACH occasions for sending the RA to the target cell from the target cell (e.g., broadcast information). For example, the WTRU may be configured, once it has determined to do the early sync towards a given target cell, it will read the system information blocks (SIBs) of the target cell to find information about the RACH occasions.

In some examples, the WTRU may be configured with one or more specific RACH pre-ambles to use for the early sync procedure (e.g., contention free RACH, contention free random access (CFRA)). The WTRU may be configured to use random RACH preambles (e.g., contention based RACH, contention based random access (CBRA)). The WTRU may be configured to use short RACH preambles for early sync recovery purposes. The WTRU may be configured to use long RACH preambles for early sync recovery purposes.

In some examples, the WTRU may receive the Random Access Response (RAR) from the target. In some examples, the WTRU may not receive the RAR from the target, but instead it may obtain the TA later via the source (e.g., if the prediction was long enough and the WTRU still has connection with the source cell, in a way like the TA was included to the LTM cell switch MAC-CE). In some examples, the WTRU may receive (in the RAR) a timing advance (TA) value to use towards the target cell on future UL communications.

In some examples, the WTRU may be configured with a validity condition associated with the timing advance (TA) value for target cell access. In some examples, the validity condition may be configured and/or expressed in terms of time. For example, the WTRU may start a timer upon reception of the timing advance (TA) value. Upon expiry of the timer the WTRU may assume that the validity of the timing advance is expired. In some examples, the validity condition may be expressed in terms of a measurement value associated with the target cell. For example, the timing advance (TA) validity may be tied to the RSRP range of the target cell. The WTRU may consider that the timing advance is valid when the difference in target cell RSRP between the time t1 and time t2 is within a preconfigured threshold. For example, the time t1 may be the time at which preamble is transmitted (e.g., for early sync). For example, the time t1 may be the time at which the RAR is received (e.g., the RAR containing the TA). For example, the time t2 may be the time at which RLF is detected. For example, the time t2 may be the time at which the recovery is triggered/performed.

When the validity condition is expired based on one or more conditions described herein, the WTRU may release the UL grant information and release the timing advance value received from the target cell. If the RLF is detected after the validity condition is expired, the WTRU may perform legacy recovery procedure (e.g., using 4-step or 2-step random access procedure).

In some examples, the WTRU may receive (e.g., in the RAR) an UL grant information (e.g., time and frequency) for sending a subsequent UL message to the target. In legacy, when the WTRU gets the UL grant after the RAR, it may be expected that the WTRU will be ready to send a subsequent message, for example, message 3 (msg3)/message 5 (msg5) (e.g., RRC setup request, RRC resume request, RRC re-establishment request, RRC reconfiguration complete and/or also known as HO complete message, etc.). However, for the problem being addressed here, it may be possible that the WTRU may be doing the early sync with the target cell a considerable time duration before it is ready to send the subsequent RRC message where the UL grant allocation in the RAR is provided for. Thus, the current format for indicating the UL grant may not be sufficient (e.g., not able to indicate a time duration, for example, in number of slots from the reception of the RAR message) for this purpose.

In some examples, the format of the UL grant information in the RAR may be enhanced from legacy format to indicate to the WTRU a time information that may be farther away than currently possible (e.g., current UL grant information in the RAR has a 4 bit time domain information for the UL grant, and an extension of this to more than 4 bits can be envisioned). The format of the UL grant information in the RAR may be kept the same as in legacy, but the way the WTRU determines the UL grant time may be modified for this purpose. For example, the WTRU may be configured on how to scale up the UL grant time. For example, if the calculation of the UL grant time according to the time information included in the UL grant info included in the RAR, according to legacy behavior and/or specification is showing that the UL grant is for T=t1+delta_1, where t1 is the time of reception of the RAR (e.g., first slot and/or RB containing the RAR, last slot and/or RB containing the RAR, etc.), the WTRU may consider the UL grant time for a subsequent UL message to the target to be T+delta_2. For example, delta_2 can be dependent on the RLF prediction time horizon and/or the T310. For example, if the WTRU was configured to do the early sync a certain configured time before RLF is predicted, then delta_2 can be set to this value (e.g., or a value derived from this).

In some examples, the WTRU may be configured with multiple RACH preambles, each corresponding to the time horizon of the prediction where the RLF is expected to occur. For example, the WTRU may be configured with preamble1, preamble2 and preamble3, each associated with prediction time horizons of t1, t2 and t3. That way, the WTRU may implicitly indicate to the target cell when the WTRU expects to send the first UL message to the target (e.g., the time where RLF is expected to occur at the source), and the target may use that information to determine the most appropriate time to allocate the resource to the WTRU (e.g., and signal it to the WTRU according to any of the solutions described above). In some examples, the WTRU may be configured with multiple RACH preambles, some preambles corresponding to recovery via re-establishment and other preambles related to recovery via CHO/LTM, so that the network could use that information to determine the UL grant size for the recovery message (e.g., as re-establishment and HO complete can have quite different sizes, where the HO complete could be considerably larger size).

In some examples, the WTRU may be provided with two UL grants in the RAR. The additional grant information, referred to as “error indication grant” henceforth, may be a very small grant (e.g., just enough to send one bit indication), which is scheduled in time before the UL grant for subsequent UL message from the WTRU to the target. For example, as described below and herein, the WTRU may be configured to use this small grant to send an indication to the target that it won't be needing the grant for subsequent UL message (e.g., if the WTRU determines the RLF prediction was wrong and/or it has now recovered the link with the source, and/or the radio link problem didn't happen at all). In some examples, an allocation of more than one bit may be provided for the cancellation message and the WTRU may use that to indicate different cause values for deciding not to use the grant for subsequent UL message as discussed below and herein. In some examples, the error-indication grant may not be explicitly indicated in the RAR but its time and/or frequency location may be specified relative to the grant time for the subsequent UL message (e.g., a certain configured time slot before the grant time for the subsequent UL message, e.g., as an absolute time duration or a relative time duration, for example, half way between the time of reception of the RAR and the grant time for the subsequent UL message).

When and where to perform the recovery may be implemented. In some examples, the WTRU may be configured to perform the recovery to a target cell that it has performed early sync in anticipation of an RLF with the current serving cell when the RLF gets detected (e.g., not just predicted). The WTRU may be configured to perform the recovery to a target cell that it has performed early sync in anticipation of an RLF at the time when the RLF was predicted even if the RLF is not detected yet.

In some examples, the WTRU may do the recovery at the time when the RLF was predicted even if RLF has not been detected yet (e.g., as in previous examples herein) only if the WTRU is still having problems with the current serving cell (e.g., T310 is running, it is not in sync with the source link yet, a certain number of OOSs have been detected since T310 has started, and/or a certain number/percentage of the RLM indications from the PHY have been OSSs within a certain configured time duration before the predicted RLF time or the UL grant time, etc.).

In some of the examples above, the WTRU may be configured to do the recovery by sending an RRC re-establishment request or the CHO/LTM complete message (e.g., depending on a CHO/LTM target being configured and it fulfills any configured radio conditions, as discussed below and herein) using the grant that was indicated in the RAR (e.g., during early sync) for a subsequent UL message.

In some examples, the WTRU may be configured to perform the recovery to a target cell that the WTRU has performed an early sync with only if that target cell is the strongest neighbor cell at that time. The WTRU may be configured to perform the recovery to a target cell that the WTRU already has performed an early sync with, if that target still fulfills certain radio conditions at the time of performing the recovery (e.g., at the UL grant time indicated in the RAR response during early sync). This radio condition may be an absolute threshold (e.g., better than a threshold) and/or relative (e.g., not worse than the strongest neighbor cell at that time by more than a certain threshold, better than the current cell by more than a certain threshold, etc.).

The WTRU may be configured to consider not only current measurements but also predicted measurement of the target cell. For example, the WTRU may be configured to determine the recovery target cell to be a target cell that the WTRU has already performed early sync with, if its signal level is expected to be the strongest for a given time duration in the future. For example, the WTRU may be configured to determine the target cell to be a cell that the WTRU has already performed early sync with if the signal level of that cell is expected to be above a certain configured threshold (e.g., or not worse than the strongest serving cell by more than a certain configured threshold, or better than the serving cell by more than a certain threshold, etc.) for a given time duration in the future.

Error handling may be implemented. In some examples, if the WTRU detects the RLF before the predicted time for RLF, the WTRU may be configured to wait until the grant time for subsequent UL message to send the recovery message. If the WTRU detects the RLF after the predicted time for RLF but still before the grant time for subsequent UL message, the WTRU may be configured to wait until the grant time for subsequent UL message to send the recovery message.

In some examples, if the WTRU detects the RLF after the grant time for subsequent UL message that was provided during early sync, the WTRU may be configured to do the recovery as in legacy (e.g., do a RACH-based re-establishment or CHO/LTM). In some examples, if the WTRU detects the RLF after the grant time for subsequent UL message that was provided during early sync, the WTRU may be configured to send a scheduling request (SR) to the target to get an UL grant for the re-establishment request or the HO complete message. The WTRU may send different SRs for the two purposes (e.g., so that the network can determine the optimal UL grant size that is suitable/sufficient for a Re-establishment request and/or the HO complete message).

In some examples, if the WTRU detects the RLF before the predicted time of the RLF and/or a given configured time duration before the time for the UL grant provided in the RAR during the early sync, the WTRU may be configured to disregard the early sync and do the recovery as in legacy (e.g., do a RACH-based recovery). For example, the WTRU may be configured with a time duration threshold, and if this time difference between the current time (e.g., time of RLF detection) and/or the UL grant time is above this configured threshold, WTRU may perform a RACH based recovery as in legacy. For example, this time duration may be a WTRU specific parameter and/or can be specified in the standards (e.g., based on the time that is required to send an RA and receive a RAR, that is, instead of waiting for the configured UL grant time, the WTRU may be able to get an earlier grant for the subsequent UL message by following legacy RACH based recovery).

Additionally and/or alternatively, the WTRU may be configured to send an SR to get a new grant for the sending of the recovery message if RLF gets detected a certain configured time before the time of the UL grant that was provided in the RAR during the early sync. In some examples, different SRs may be used for the re-establishment vs the CHO/LTM case.

In some examples, the WTRU may detect that the RLF prediction was wrong based on one or more of the following. For example, the WTRU may detect that the RLF prediction was wrong based on the link with the source recovered before T310 has started (e.g., if prediction was made before T310 has started, if the WTRU action was based only on phase 1 prediction as discussed above, etc.). The WTRU may detect that the RLF prediction was wrong based on T310 gets stopped (e.g., early sync may have been performed before or after T310 has started according to any of the solutions above, but T310 is stopped due to the WTRU getting back in sync with the source). The WTRU may detect that the RLF prediction was wrong based on the WTRU made a new RLF prediction and that indicates that RLF is not expected to occur as predicted before (e.g., no RLF predicted for a long duration, RLF predicted but it is at a time duration farther away from the previous prediction or farther away from the UL grant time indicated in the RAR, etc.). The WTRU may detect that the RLF prediction was wrong based on the predicted RLF time and/or window has elapsed but RLF has not been detected or T310 has not started, etc.).

In some examples, when the WTRU has determined that the RLF prediction was wrong, the WTRU may be configured to send a (e.g., cancellation) indication to the network (e.g., so that the network can re-allocate, to another WTRU, the UL grant that was reserved for this WTRU to do recovery to the target cell during early sync). In some examples, this cancellation indication may be sent to the source cell (e.g., the source gNB and/or distributed unit (DU) and/or cell may then indicate that to the target gNB and/or DU and/or cell, and/or the source and target cells may be controlled by the same gNB and/or DU such communication may not even be necessary). In some examples, this cancellation indication may be sent to the target cell, using the error-indication grant that was also indicated in the RAR message during early sync (e.g., or the implied error-indication grant time based on specifications as described above and herein).

In some examples, if the RLF gets detected before the predicted RLF time, the WTRU may use the error-indication grant time to indicate to the network that RLF has occurred before the anticipated time (e.g., thereby making it possible for the network to provide an UL grant to be available earlier than the previously allocated time for the WTRU during early sync). This grant may also be used to send an SR to the target (e.g., if the SR configuration for the physical uplink control channel (PUCCH) of the target is known and/or configured at the WTRU).

In some examples, the WTRU may use different values to indicate an earlier RLF or no-RLF, as discussed above and herein, in the error-indication message. For example, a “0” may indicate that RLF has occurred earlier than expected, and a “1” may indicate that RLF is no more expected to occur, and/or vice versa. Additionally and/or alternatively, the WTRU may be configured to send a 2 bit indication, where a “00” may indicate that RLF has occurred and/or is expected to occur as predicted and WTRU may use the UL grant indicated during the early sync for recovery, “01” indicating that the RLF has occurred earlier than expected, “10” indicating that RLF is no more expected to occur and so on. Additionally and/or alternatively, the WTRU may skip the usage of the error-indication grant if nothing has changed about the RLF prediction (e.g., the network may assume that things are going as expected and/or predicted if it doesn't receive any indication from the WTRU at the expected time).

In some examples, the error-indication message may be a L1/L2 message (e.g. an uplink control channel (UCI)). The error-indication message may be a MAC-CE. The error-indication message may be an RRC message.

In some examples, the WTRU may send an indication that the RLF did not occur and/or is not expected to occur by sending another RA message to the target. In one example, this may done using the same preamble that was used during the early sync. In another example, the WTRU may be provided with one or more “cancellation” preamble(s) and it uses this preamble to indicate that to the target. If an RA message is sent for cancellation purposes, the WTRU may be configured to not wait for a RAR for that message.

WTRU reporting of RLF predictions may be implemented. In some examples, the WTRU may be configured to report information related to an RLF prediction (e.g., indication that RLF is expected to occur at a given time from now or within a given time window). In some examples, the WTRU may be configured to send a report regarding phase 1 (e.g., an indication that the T310 is expected to start a given time and/or a time window). The WTRU may be configured to send a report regarding phase 2 (e.g., an indication that the T310 is expected to expire before recovery of the source link). The WTRU may be configured to send additional information in the RLF prediction.

In some examples, the additional information could be time related information (e.g., time and/or time window when the RLF is expected to occur, or where T310 is expected to start, etc.). Additionally and/or alternatively, the time information may be an implicit information (e.g., the WTRU may have already indicated the time horizon or lead time and/or window of the prediction in the WTRU capability). The additional information may be confidence level information of the prediction. Additionally and/or alternatively, the confidence level could be implicit information (e.g., the WTRU may have already indicated the confidence level of the prediction in the WTRU capability). The additional information may be related to measurements of current and neighbor cells. The additional information may be detailed measurements (e.g., RSRP/RSRQ, etc.) of these cells, and/or an order and/or list of the strongest neighbor cells (e.g., the top n cells, where n is configured by the network).

In some examples, the measurement information may be based on current measurements. The measurement information may be based on predicted measurements (e.g., at the time where the RLF is predicted to happen). The measurement information may be based on both current and predicted measurements (e.g., include both current and/or predicted measurements of the neighbor cell, include the top n cells based on predicted measurements, and/or include the top n cells based on the average of the current and predicted measurements, etc.).

In some examples, the WTRU may receive, in response to the RLF report indication it has according to any of the solutions above, a message from the network. The response message may include one or more of the following information the WTRU may use for performing the recovery according to any of the solutions above. For example, the response may include an indication of one or more recovery cell(s). The response may include a CHO/LTM configuration to one or more of the recovery cell(s). The response may include RA related parameters for one or more of the recovery cell(s) (e.g., RACH preambles to be used for early sync, RACH occasions, etc.). The response may include signal level thresholds (e.g., for choosing CHO/LTM targets for recovery, etc. as described above and herein).

In some examples, the WTRU may receive a PDCCH order from the serving cell indicating to perform a RACH for early sync. Unlike the PDCCH order for early sync in the case of LTM, the WTRU, in this case, may receive the RAR from the target.

In some examples, the WTRU may already have received CHO/LTM configurations for the target cells, before it has sent the RLF prediction report, and the response message from the network to the prediction report may be an indication to activate one or more of these CHO/LTM configuration (e.g., the WTRU may start monitoring the triggering conditions for these targets only after it has received this activation indication from the network).

In some examples, the WTRU may not receive any response from the network after sending an RLF prediction report (e.g., all the configuration information related to recovery may have been received by the WTRU before the sending of the RLF prediction report, and the RLF report may be used by the network to do some preparation, for example, admission control at target cells, WTRU context transfer to neighboring cells, etc.).

In some examples, the WTRU may have received some of the configuration information related to recovery before sending the RLF prediction report, and the WTRU may receive the remaining information after the sending of the RLF prediction. For example, the WTRU may have received the legacy CHO/LTM configurations beforehand, and after the sending of the RLF prediction report, the network may configure the WTRU with other information related to recovery discussed above to be used when/if the RLF gets detected.

Other aspects and generalizations of the methods discussed herein may be implemented. In some examples, when the WTRU sends a RA preamble to a CHO/LTM target, it may be due to the (e.g., legacy) CHO/LTM conditions being fulfilled (e.g., before RLF prediction/detection). In some examples, the WTRU may be configured to indicate whether the RA is being sent due to this (e.g., legacy CHO/LTM conditions being fulfilled) and/or for early sync due to RLF prediction as discussed above and herein. The indication may be done, for example, by using different RACH preambles for the two cases.

In some examples, the WTRU may be configured to start a timing advance timer (TAT) for the target cell as soon as it has acquired the TA to that cell after the early sync (e.g., where the time duration is configured by the network or specified in the standards), and/or it may consider the TA with that cell to be valid as long as the TAT has not expired. For instance, if the WTRU performs recovery towards that cell before the TAT expires, the WTRU may use RACH-less recovery. For instance, even if the RLF never happens, and the WTRU later receives a HO command towards a target that it has already early synced with and TAT has not expired, WTRU may perform a RACH-less recovery (e.g., sending an SR to get an UL grant for the HO complete message).

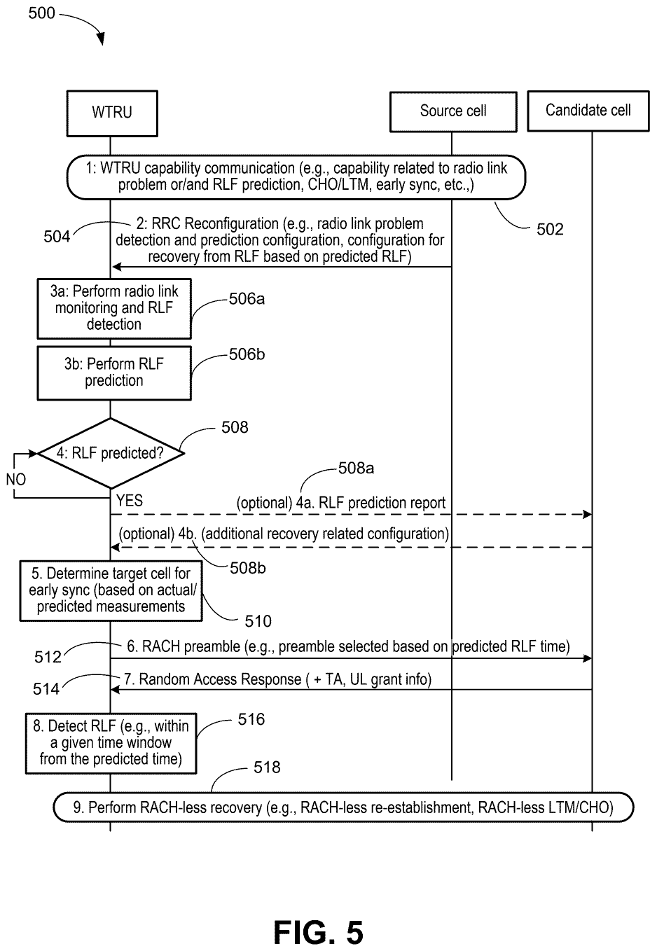

FIG. 5 is an example of a procedure 500 for performing RACH-less recovery. The procedure 500 may be performed by a WTRU. The procedure 500 may be start at 502. At 502, the WTRU may inform the network about capabilities related to radio link problem and/or radio link recovery and/or radio link failure prediction, as well as capability related to LTM/CHO support. At 504, the WTRU may receive a configuration regarding a radio link problem and/or a RLF prediction. The configuration may contain one or more of the following. For example, the configuration may contain parameters related to radio link problem determination and prediction (e.g., N310 counter values, lead time, confidence levels, etc.). The configuration may contain recovery related information (e.g., CHO/LTM target cells, RACH pre-ambles, thresholds for determining whether a certain target can be used for recovery, etc.). The WTRU may be configured to send a prediction report. Some of the configuration information provided in 502 may be provided in later signaling (e.g., at 508b), and/or may be specified in standards.

At 506a, the WTRU may perform RLM and/or detection of RLF (e.g., in legacy mode). At 506b, the WTRU may perform the prediction of radio link problem/RLF according to the received parameters. If RLF prediction reporting was configured, the WTRU may start monitoring the radio link problem reporting configurations. In some examples, the conditions for predicting the problem and/or sending the report are the same (e.g., WTRU may send the report, if configured, when the radio link problem/RLF is predicted). In other examples, the conditions for predicting the problem and/or sending the prediction report may be different.

At 508, the WTRU may predict that an RLF is going to occur. At 508a, if reporting was configured, the WTRU may send the radio link prediction report and include any additional information according to the configuration (e.g., measurement information, time information, confidence levels, etc.). At 508b, in response to the report sent in 508a, the WTRU may receive additional recovery related configuration (such as CHO/LTM configurations, thresholds, RACH preambles, etc.).

At 510, the WTRU may determine the target cell to perform the early sync to (e.g., based on the configurations received in messages 504 and/or 508b). At 512, the WTRU may perform early sync with the target via a random access procedure, choosing the proper preamble that was configured for that purpose. At 514, the WTRU may get a RAR from the target, which includes a TA to the target and an UL grant to be used if and/or when the RLF happens. At 516, the WTRU may detect RLF (e.g., within a given time window from the predicted time, before the time of the UL grant indicated during the early sync). At 518, if the target cell was not configured and/or prepared for CHO, the WTRU may initiate a RACH-less re-establishment procedure (e.g., send an RRC re-establishment request using the UL grant it has been indicated at 514).

1. A wireless transmit/receive unit (WTRU) comprising:
a processor configured to:
send capability information related to radio link failure (RLF) prediction based on an artificial intelligence (AI)/machine learning (ML) model;
receive configuration information associated with radio link monitoring (RLM) and RLF detection and prediction, wherein the configuration information comprises an early synchronization configuration associated with a target cell for RLF recovery;
predict radio link failure of a serving cell of the WTRU at a predicted RLF time;
perform early synchronization with the target cell based on the early synchronization configuration;
detect a RLF of the serving cell at the predicted RLF time or within a time window that includes the predicted RFL time; and
perform a recovery of a connection via the target cell.

2. The WTRU of claim 1, wherein the capability information is sent and the configuration information received via the serving cell.

3. The WTRU of claim 1, wherein the early synchronization configuration comprises a plurality of random access channel (RACH) preambles, wherein each RACH preamble of the plurality of RACH preambles are associated with a respective predicted RLF time.

4. The WTRU of claim 1, wherein, to perform the early synchronization with the target cell, the processor is configured to:
send a RACH preamble associated with the predicted RLF time to the target cell; and
receive a random access response (RAR) from the target cell, where in the RAR comprises a timing advance (TA) and an uplink (UL) grant information associated with the target cell.

5. The WTRU of claim 4, wherein the processor is configured to apply the received TA for subsequent UL transmissions towards the target cell.

6. The WTRU of claim 4, wherein the processor is configured to perform a radio resource control (RRC) re-establishment to perform the recovery of the connection via the target cell, wherein the processor is configured to send an RRC re-establishment request message to the target cell using resources indicated in the UL grant information, and receive an RRC re-establishment message from the target cell.

7. The WTRU of claim 6, wherein the RRC re-establishment request message comprises one or more of cell radio network temporary identifier (C-RNTI), physical channel identity (PCI), or security integrity information derived based on security configuration at the serving cell.

8. The WTRU of claim 4, wherein, to perform the recovery of the connection via the target cell, the processor is configured to:
receive a conditional handover (CHO) configuration corresponding with the target cell; and
send a CHO complete message to the target cell using resources indicated in the UL grant information.

9. A method performed by a wireless transmit/receive unit (WTRU), the method comprising:
sending capability information related to radio link failure (RLF) prediction based on an artificial intelligence (AI)/machine learning (ML) model;
receiving configuration information associated with radio link monitoring (RLM) and RLF detection and prediction, wherein the configuration information comprises an early synchronization configuration associated with a target cell for RLF recovery;
predicting radio link failure of a serving cell of the WTRU at a predicted RLF time;
performing early synchronization with the target cell based on the early synchronization configuration;
detecting a RLF of the serving cell at the predicted RLF time or within a time window that includes the predicted RFL time; and
performing a recovery of a connection via the target cell.

10. The method of claim 9, wherein the capability information is sent and the configuration information received via the serving cell.

11. The method of claim 9, wherein the early synchronization configuration comprises a plurality of random access channel (RACH) preambles, wherein each RACH preamble of the plurality of RACH preambles are associated with a respective predicted RLF time.

12. The method of claim 9, wherein, to perform the early synchronization with the target cell, the method further comprises:
sending a RACH preamble associated with the predicted RLF time to the target cell; and
receiving a random access response (RAR) from the target cell, where in the RAR comprises a timing advance (TA) and an uplink (UL) grant information associated with the target cell.

13. The method of claim 12, wherein the method further comprises applying the received TA for subsequent UL transmissions towards the target cell.

14. The method of claim 12, wherein the method further comprises performing a radio resource control (RRC) re-establishment to perform the recovery of the connection via the target cell, wherein the method further comprises sending an RRC re-establishment request message to the target cell using resources indicated in the UL grant information, and receiving an RRC re-establishment message from the target cell.

15. The method of claim 14, wherein the RRC re-establishment request message comprises one or more of cell radio network temporary identifier (C-RNTI), physical channel identity (PCI), or security integrity information derived based on security configuration at the serving cell.

16. The method of claim 12, wherein, to perform the recovery of the connection via the target cell, the method further comprises:
receiving a conditional handover (CHO) configuration corresponding with the target cell; and
sending a CHO complete message to the target cell using resources indicated in the UL grant information.

17. A wireless transmit/receive unit (WTRU) comprising:
a processor configured to:
send capability information related to radio link failure (RLF) prediction based on an artificial intelligence (AI)/machine learning (ML) model;
receive configuration information associated with radio link monitoring (RLM) and RLF detection and prediction, wherein the configuration information comprises an early synchronization configuration associated with a target cell for RLF recovery;
receive a random access response (RAR) from the target that includes a timing advance (TA) and indication of at least one uplink (UL) grant information;
predict radio link failure of a serving cell of the WTRU at a predicted RLF time;
perform early synchronization with the target cell based on the early synchronization configuration;
determine that RFL did not occur; and
send an indication to the target cell that RLF did not occur so that target cell can release the uplink (UL) grant.
